(19) United States
(12) Patent Application Publication
(10) Pub. No.: US 2015/0018202 A1
(43) Pub. Date: Jan. 15, 2015

(54) Variations of Loading of Zero-PGM Oxidation Catalyst on Metallic Substrate

(71) Applicants: Zahra Nazarpoor, Camarillo, CA (US); Sen Kitazumi, Oxnard, CA (US); Johnny T. Ngo, Oxnard, CA (US)

(72) Inventors: Zahra Nazarpoor, Camarillo, CA (US); Sen Kitazumi, Oxnard, CA (US); Johnny T. Ngo, Oxnard, CA (US)

(73) Assignee: CDTI, Ventura, CA (US)

(21) Appl. No.: 13/941,033

(22) Filed: Jul. 12, 2013

(51) Int. Cl. B01J 23/83

(52) U.S. Cl. CPC B01J 23/83
USPC 502/303; 502/304

(57) ABSTRACT

The present disclosure refers to processes and formulations employed for optimization of variations of Zero-PGM catalyst coated on metallic substrates. Deposition of a uniform and well-adhered layer of catalyst on the metallic substrate may be enabled by the selection of a washcoat loading resulting from variation of metal loadings. Characterization of catalysts may be performed using a plurality of catalytic tests, including but not limited to washcoating adherence test, back pressure test, inspection of textural characteristics, and catalyst activity. Optimized variations may be applied to a plurality of metallic substrates for achieving coating uniformity, desired level of WCA loss, and optimized performance of catalyst activity.

### CROSS-REFERENCE TO RELATED APPLICATIONS

The application is related to U.S. Ser. No. 13/927,872, titled Optimization of Zero-PGM Catalyst Systems on Metallic Substrates, filed on Jun. 26, 2013, the entirety of which is incorporated by reference herein.

### BACKGROUND

1. Technical Field

The present disclosure relates generally to Zero-PGM catalyst systems, and more particularly, to optimization of variations of Zero-PGM catalyst loading on metallic substrates.

2. Background Information

A variety of metallic substrates normally may have a lower specific heat capacity than ceramic material, which may allow catalyst systems on metallic substrates to reach the required operating temperature more quickly after a cold start. Metallic substrates may be less brittle than ceramic substrates, which in turn may allow their installation in places where a catalyst systems based on ceramic substrates, may not be installed without risk of suffering damage as a result of shocks and vibration, in both diesel and gasoline engines.

Nowadays, with more rigorous regulations forcing catalyst manufacturers to devise new technologies to ensure a high catalytic activity, a major problem in the manufacturing of catalyst systems may be achieving the required adhesion of a washcoat and/or overcoat to a metallic substrate. Coating on metallic substrates may be affected by type of materials used and other factors, which include, but are not limited to, substrate geometry and size, substrate cell density, washcoat (WC) and overcoat (OC) particle size and distribution, additive properties, amounts of WC and OC loadings, ratio of alumina to oxygen storage material (OSM), and treatment condition.

It may be highly desirable to have optimized loading of ZPGM catalyst systems on metallic substrates, capable to produce lower loss of adhesion and improved catalyst performance with similar, or better efficiency as the prior art catalyst systems.

### SUMMARY

The present disclosure may provide optimized variations of Zero Platinum Group Metal (ZPGM) catalyst loading on metallic substrates, for overcoming the problem of low adherence of the washcoating, and enable producing optimal coating uniformity of metallic substrates. Improved behavior of catalyst under back pressure (BP) conditions, lower % of washcoat adhesion (WCA) loss, and improved catalyst performance may be achieved by optimization of loading of ZPGM catalyst systems on metallic substrates.

According to embodiments in present disclosure, compositions of ZPGM catalyst systems may include any suitable combination of a metallic substrate, a washcoat, and an overcoat which includes copper (Cu), cerium (Ce), and other metal combinations. ZPGM catalyst samples of specific substrate geometry and cells per square inch (CPSI) may be prepared using any suitable synthesis method as known in current art. The process may provide an enhanced preparation procedure to obtain a homogeneous coating on substrate structure and a well adhered washcoating and/or overcoating.

Fresh and aged catalyst samples may have controlled coating parameters such as washcoat loading, overcoat loading, overcoat pH, and WC and OC particle size. The catalyst samples may be subsequently characterized examining catalyst sample behavior under BP conditions, inspection for coating uniformity of cross section surface area of the catalyst samples, % of WCA loss, and catalyst oxidation activity under exhaust lean condition, with comparison of HC and CO oxidation which may result from variations of WC loadings used in the present disclosure.

Variation of WC loading which results in better available active surface area, better uniformity of coating, lower light-off, and optimized WCA loss, may be used in processing other metallic substrates geometries, sizes, and cell densities. The process of optimizing a ZPGM catalyst loading on metallic substrate may produce the optimal reduction in WCA loss and enhanced catalyst activity and performance of ZPGM catalyst systems.

Numerous objects and advantages of the present disclosure may be apparent from the detailed description that follows, and the drawings which illustrate the embodiments of the present disclosure, which are incorporated herein for reference.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 depicts verification of WC loading and reproducibility for a D40 mm×L60 mm, 300 cells per square inch (CPSI) metallic substrate, according to an embodiment.

FIG. 2 shows verification of back pressure for fresh ZPGM catalyst samples on D40 mm×L60 mm, 300 CPSI metallic substrate, according to an embodiment.

FIG. 3 depicts verification of coating uniformity for D40 mm×L60 mm 300 CPSI metallic substrate with WC loading of 100 g/L and OC loading of 120 g/L, according to an embodiment.

FIG. 4 shows a cross section image of ZPGM catalyst samples on a D40 mm×L60 mm, 300 CPSI metallic substrate, WC loadings of 120 g/L and OC loading 120 g/L, according to an embodiment.

FIG. 5 presents verification of % WCA loss for fresh ZPGM catalyst samples on a D40 mm×L60 mm, 300 CPSI metallic substrate, according to an embodiment.

FIG. 6 illustrates catalyst activity profiles in HC and CO conversion for fresh ZPGM catalyst samples on a D40 mm×L60 mm, 300 CPSI metallic substrate, according to an embodiment.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### Definitions

As used here, the following terms have the following definitions:

“Substrate” may refer to any material of any shape or configuration that yields a sufficient surface area for depositing a washcoat and/or overcoat.

“Washcoat” may refer to at least one coating including at least one oxide solid that may be deposited on a substrate.

“Overcoat” may refer to at least one coating that may be deposited on at least one washcoat layer.

“Catalyst” may refer to one or more materials that may be of use in the conversion of one or more other materials.

“Zero platinum group (ZPGM) catalyst” may refer to a catalyst completely or substantially free of platinum group metals.

“Co-precipitation” may refer to the carrying down by a precipitate of substances normally soluble under the conditions employed.

“Milling” may refer to the operation of breaking a solid material into a desired grain or particle size.

“Carrier material oxide (CMO)” may refer to support materials used for providing a surface for at least one catalyst.

“Oxygen storage material (OSM)” may refer to a material able to take up oxygen from oxygen rich streams and able to release oxygen to oxygen deficient streams.

“Treating,” “treated,” or “treatment” may refer to drying, firing, heating, evaporating, calcining, or combinations thereof.

“Calcination” may refer to a thermal treatment process applied to solid materials, in presence of air, to bring about a thermal decomposition, phase transition, or removal of a volatile fraction at temperatures below the melting point of the solid materials.

“Conversion” may refer to the chemical alteration of at least one material into one or more other materials.

“T50” may refer to the temperature at which 50% of a material is converted.

### DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

Variations of ZPGM Catalyst System Configuration and Composition

Optimized variation of ZPGM catalyst system may include at least a metallic substrate, a washcoat (WC), and an overcoat (OC). WC and OC may include at least one ZPGM catalyst. WC may be formed on a metallic substrate by suspending the oxide solids in water to form aqueous slurry and depositing the aqueous slurry on substrate as washcoat. Subsequently, in order to form ZPGM catalyst system, OC may be deposited on WC, according to an embodiment.

Variations of Metallic Substrates

There is a wide range of variations of metallic substrates, such as metal honeycomb, form of beads or pellets or of any suitable form. If substrate is a metal honeycomb, the metal may be a heat-resistant base metal alloy, particularly an alloy in which iron and chromium is a substantial or major component. The surface of the metal substrate may be oxidized at temperatures higher than 1000° C. to improve the corrosion resistance of the alloy by forming an oxide layer on the surface of the alloy.

Metallic substrate may be a monolithic carrier having a plurality of fine, parallel flow passages extending through the monolith. The passages may be of any suitable cross-sectional shape and/or size. The passages may be trapezoidal, rectangular, square, sinusoidal, hexagonal, oval, or circular, although other shapes may be suitable. The monolith may contain from about 9 to about 1,200 or more gas inlet openings or passages per square inch of cross section, although fewer passages may be used.

WC Material Composition and Preparation

The WC material composition may free of ZPGM transition metal catalyst. A WC may include support oxides material referred to as carrier material oxides (CMO) which may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof.

The material composition of WC may also include other components, such as acid or base solutions or various salts or organic compounds that may be added to adjust rheology of the WC slurry. These compounds may be added to enhance the adhesion of washcoat to the metallic substrate. Compounds that may be used to adjust the rheology may include ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol, amongst others.

Subsequently, mixed WC materials may be milled down into smaller particle sizes during a period of time from about 10 minutes to about 10 hours, depending on the batch size, kind of material and particle size desired. According to embodiments in the present disclosure WC particle size of the WC slurry may be of about 4 μm to about 10 μm in order to get uniform distribution of WC particles.

According to an embodiment, the milled WC in the form of aqueous slurry may be deposited on a metallic substrate, may employ vacuum dosing and coating systems and may be subsequently treated. A plurality of deposition methods may be employed, such as placing, adhering, curing, coating, spraying, dipping, painting, or any known process for coating a film on at least one metallic substrate.

If the metallic substrate is a monolithic carrier with parallel flow passages, WC may be formed on the walls of the passages. Various capacities of WC loadings in the present disclosure may be coated on the metallic substrate. The WC loading may vary from 60 g/L to 200 g/L.

According to embodiments in the present disclosure, after depositing WC on the metallic substrate WC may be treated by drying and heating. For drying the WC, air knife drying systems may be employed. Heat treatments may be performed using commercially-available firing (calcination) systems. The treatment may take from about 2 hours to about 6 hours, preferably about 4 hours, and at a temperature of about 300° C. to about 700° C., preferably about 550° C. After WC is treated and cooled at room temperature, OC may be deposited on WC.

OC Material Composition and Preparation

The overcoat may include ZPGM transition metal catalysts, including at least one or more transition metals, and at least one rare earth metal, or mixture thereof that are completely free of platinum group metals. The transition metals may be a single transition metal, or a mixture of transition metals which may include chromium, manganese, iron, cobalt, nickel, niobium, molybdenum, tungsten, and Cu.

In the present disclosure, preferably, the ZPGM transition metal may be Cu. Preferred rare earth metal may be cerium (Ce). The total amount of Cu catalyst included in OC may be of about 5% by weight to about 50% by weight of the total catalyst weight, preferably of about 10% to 16% by weight. Furthermore, the total amount of Ce catalyst included in OC may be of about 5% by weight to about 50% by weight of the total catalyst weight, preferably of about 12% to 20% by weight. Different Cu and Ce salts such as nitrate, acetate, or chloride may be used as ZPGM catalysts precursors. OC may include CMOs. CMOs may include aluminum oxide, doped aluminum oxide, spinel, delafossite, lyonsite, garnet, perovksite, pyroclore, doped ceria, fluorite, zirconium oxide, doped zirconia, titanium oxide, tin oxide, silicon dioxide, zeolite, and mixtures thereof.

According to embodiments in present disclosure, CMO in the OC may be any type of alumina or doped alumina. The doped aluminum oxide in OC may include one or more selected from the group consisting of lanthanum, yttrium, lanthanides and mixtures thereof. CMO may be present in OC in a ratio between 40% to about 60% by weight. Additionally, according to embodiments in the present disclosure, OC may also include OSM. Amount of OSM may be of about 10% to about 90% by weight, preferably of about 40% to about 75% by weight. The weight of OSM is on the basis of the oxides.

The OSM may include at least one oxide selected from the group consisting of zirconium, lanthanum, yttrium, lanthanides, actinides, Ce, and mixtures thereof. OSM in the present OC may be a mixture of ceria and zirconia; more suitable, a mixture of (1) ceria, zirconia, and lanthanum or (2) ceria, zirconia, neodymium, and praseodymium, and most suitable, a mixture of cerium, zirconium, and neodymium. OSM may be present in OC in a ratio between 40% to about 60% by weight. Cu and Ce in OC are present in about 5% to about 50% by weight or from about 10% to 16% by weight of Cu and 12% to 20% by weight of Ce.

The OC may be prepared by co-precipitation synthesis method. Preparation may begin by mixing the appropriate amount of Cu and Ce salts, such as nitrate, acetate, or chloride solutions, where the suitable Cu loadings may include loadings in a range as previously described. Subsequently, the Cu—Ce solution is mixed with the slurry of CMO support. Co-precipitation of the OC may include the addition of appropriate amount of one or more of NaOH solution, Na₂CO₃ solution, and ammonium hydroxide (NH₄OH) solution. The pH of OC slurry may be adjusted to 5.0 to 7.0 by adjusting the rheology of the aqueous OC slurry adding acid or base solutions or various salts or organic compounds, such as, ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol, and other suitable compounds.

The OC slurry may be aged at room temperature for a period of time of about 12 to 24 hours under continues stirring. This precipitation may be formed over slurry including at least one suitable CMO, or any number of additional suitable CMOs, and may include one or more suitable OSMs as previously described. After precipitation, the OC slurry may be deposited on WC by employing suitable deposition techniques such as vacuum dosing, amongst others.

The OC loading may vary from 60 g/L to 200 g/L. OC may then be dried and treated employing suitable heat treatment techniques employing firing (calcination) systems or any other suitable treatment techniques. The ramp of heating treatment may vary. In an embodiment, treating of washcoat may not be required prior to application of overcoat. In this case, OC, WC, and metallic substrate may be treated for about 2 hours to about 6 hours, preferably about 4 hours, at a temperature of about 300° C. to about 700° C., preferably about 550° C.

Parameters for Optimization of Variations of ZPGM Catalyst on Metallic Substrates

WC loadings, back pressure, and WCA may be controlled to have better uniformity of coating, reduction of WCA loss, and higher catalyst activity. Varying washcoat loadings may have an influence in coating uniformity, WCA, and performance of ZPGM catalyst systems on metallic substrates. The control parameters that may be used in the present disclosure may include a plurality of washcoat loadings to prepare ZPGM catalyst samples on a metallic substrate with a specific geometry and concentration.

The fresh and aged catalyst samples may be characterized and tested for verification of behavior under back pressure conditions, coating uniformity, desired level of WCA loss, and catalyst activity. The optimal results from variations of washcoat loadings may be registered and applied to a plurality of metallic substrates for verification of catalyst performance.

The following example is intended to illustrate the scope of the disclosure. It is to be understood that other procedures known to those skilled in the art may alternatively be used.

### EXAMPLE #1

### Optimization of Variations of ZPGM Loadings on Metallic Substrate

Example #1 may illustrate the optimization of variations of ZPGM loadings on a D40 mm×L60 mm, 300 CPSI metallic substrate. Processing parameters may be used to prepare catalyst samples and to control coating uniformity, behavior under back pressure, % WCA loss, and catalyst activity. Accordingly, catalyst samples may be prepared to include WC loadings of 60 g/L, 80 g/L, 100 g/L, and 120 g/L. The OC is prepared with a total loading of 120 g/L.

WC may include alumina as support oxide. WC is free of OSM and ZPGM material. The WC is prepared by milling process and the particle size of washcoat adjusted to about 6.0-7.0 μm by controlling the time of milling. The OC is prepared by co-precipitation method at pH=5.0-6.0 and may have a total loading of 120 g/L, including Lanthanum-doped alumina as CMO, and OSM. Overcoat include Cu with a loading of 10 g/L to 15 g/L and Ce with loading of 12 g/L to 18 g/L. Samples may be fired at 550C for 4 hours which are considered as fresh samples. In addition, some samples may be aged at 900° C. for 4 hours under dry condition. and considered as aged samples.

Fresh and aged catalyst samples may be prepared using the variations of WC loading, all samples may be subjected to characterization and testing for verification of washcoat loading and reproducibility; verification of behavior under back pressure; inspection coating uniformity in the cross sections of substrate; verification of washcoat adherence in terms of % WCA loss; and catalyst oxidation activity under exhaust lean condition. Analysis of catalyst activity of samples may employ the resulting HC T50 to compare the activity in HC conversion of the catalyst samples.

Verification of Washcoat Loading and Reproducibility

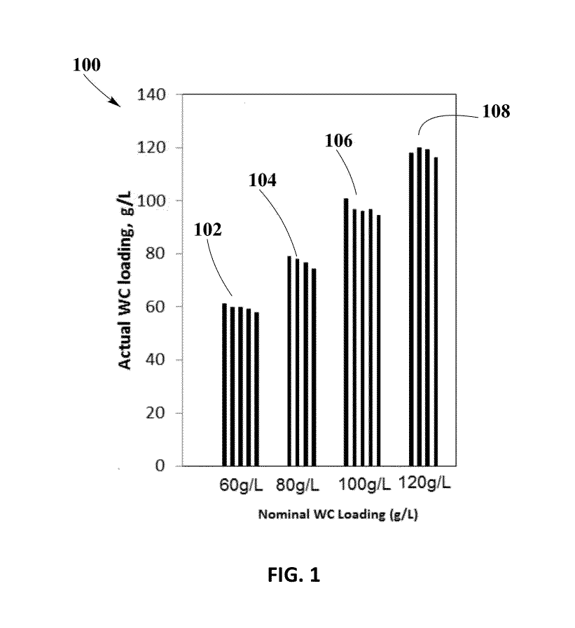

FIG. 1 shows verification of WC loading and reproducibility 100 for a ZPGM catalysts coated on a D40 mm×L60 mm, 300 CPSI metallic substrate, of example #1. Bar chart 102 shows reproducibility of coating loading for nominal WC loading of 60 g/L; bar chart 104, shows reproducibility of coating loading for nominal WC loading of 80 g/L; bar chart 106 shows reproducibility of coating loading for nominal WC loading of 100 g/L; and bar chart 108 shows reproducibility of coating loading for WC loading of 120 g/L. OC loading for all samples may be targeted at 120 g/L and during monitoring, actual OC loading may be obtained within ±5% of target.

As may be seen in bar chart 102, from a total of 5 samples, the reproducibility that may be obtained is within a range from about −3.85% to about 2.11% within target of 60 g/L. In bar chart 104 may be seen that from 4 samples reproducibility is within a range from −7.16% to about −1.2% within target of 80 g/L. In bar chart 106 may be seen that from a total of 5 samples reproducibility is within a range from about −5.71% to about 0.79% within target of 100 g/L. In bar chart 108 may be seen that from 4 samples reproducibility is within a range from −3.07% to about −0.09% within target of 120 g/L.

The verification of washcoat loading and reproducibility indicate that samples variation of WC loading does not influence the actual loading of coating and reproducibility of loading.

Verification of Back Pressure

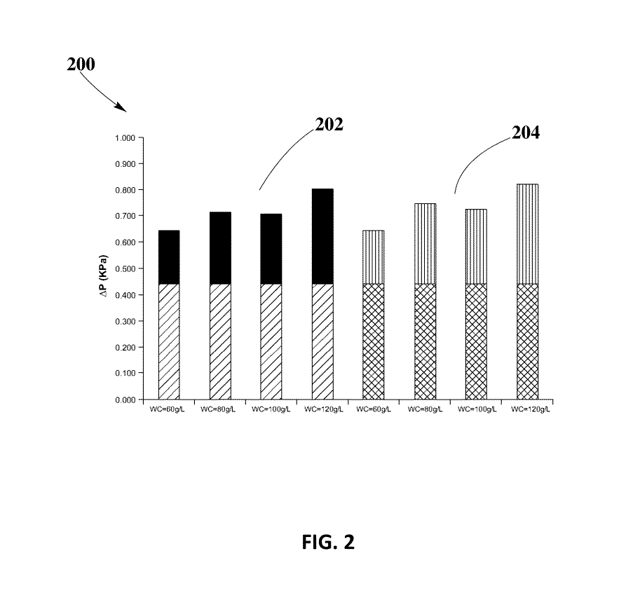

FIG. 2 illustrates verification of BP 200 for fresh ZPGM catalyst samples on D40 mm×L60 mm, 300 CPSI metallic substrate, of example #1. For comparison of variations of back pressure, testing may be performed on a blank metallic substrate and a coated substrate varying WC loadings of 60 g/L, 80 g/L, 100 g/L, and 120 g/L. Back pressure testing may be performed on both sides of the substrate having an air flow of 1.0 m³/min, at 25° C.

As may be seen in verification of BP 200, bar chart 202 shows results of testing fresh samples on one side of blank metallic substrates (slanted line bars) with inlet to outlet direction and on the same side using coated metallic substrates (solid black bars). Bar chart 204 shows results of testing fresh samples on the opposite side of blank metallic substrates of bar chart 202 (mesh pattern bars) with outlet to inlet direction and on the same opposite side using coated metallic substrates (vertical line bars). As may be seen in bar chart 202 and 204, for both sides with blank metallic substrate or coated metallic substrate, BP is approximately constant, only showing a greater BP for WC loading of 120 g/L.

When testing is performed inlet-outlet side of blank metallic substrates, BP slightly changes from about 0.442 kPa to about 0.446 kPa for the opposite side (outlet-inlet) of the blank metallic substrates showing no clogged cells in the blank substrate. When results from testing coated metallic substrates may be compared from one side to the other, it may be seen that for WC loading of 60 g/L, BP changes from about 0.643 kPa to about 0.645 kPa; for WC loading of 80 g/L, BP changes from 0.714 kPa to 0.746 kPa; for WC loading of 100 g/L, and BP changes from 0.708 kPa to 0.726 kPa, which shows uniformity of coating on substrate's cells. However, for WC loading of 120 g/L, BP changes from 0.804 kPa to 0.821 kPa. This level of BP may be due to presence of thick coating and catalyst samples with WC loading of 60 g/L, 80 g/L, and 100 g/L may be within the acceptable range for optimized catalyst activity.

Verification of Coating Thickness and Uniformity

Coating uniformity of prepared catalyst samples of example #1 may be verified by visual inspection of cross section of each coated substrate. After resin molding, the catalyst samples are cut and subsequently sanded.

Visual inspections of the thickness and coating uniformity in the WC and OC of the metallic substrate may be performed for WC loadings of 60 g/L, 80 g/L, 100 g/L, and 120 g/L. Visual inspections may be performed and pictures of the sections taken at the inlet and outlet sections of substrate and at the center of the cross sections. From these inspections a reference washcoat loading may be obtained for optimization of metallic substrates according to principles in the present disclosure.

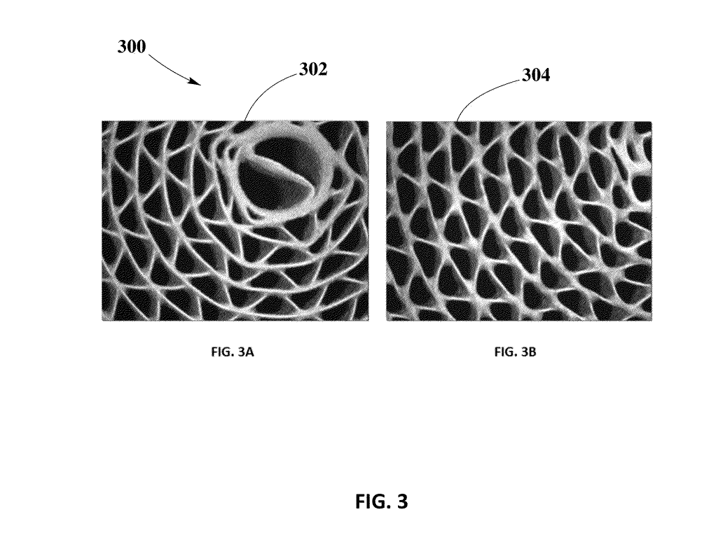

FIG. 3 presents verification of coating uniformity 300 for D40 mm×L60 mm, 300 CPSI metallic substrate of example #1. FIG. 3A depicts coating uniformity 302 at the inlet of catalyst sample with WC loading of 100 g/L and OC loading of 120 g/L. FIG. 3B depicts coating uniformity 304 at the outlet of catalyst sample with WC loading of 100 g/L and OC loading of 120 g/L. A visual inspection shows uniform coating thickness at top and bottom of substrate.

From coating uniformity 302 and coating uniformity 304 may be observed that there is coating uniformity at the inlet and outlet of catalyst sample prepared with WC loading of 100 g/L and OC loading of 120 g/L. After coating verification, can be observed the same textural characteristics of uniform coating, and even distribution of coating in inlet and outlet.

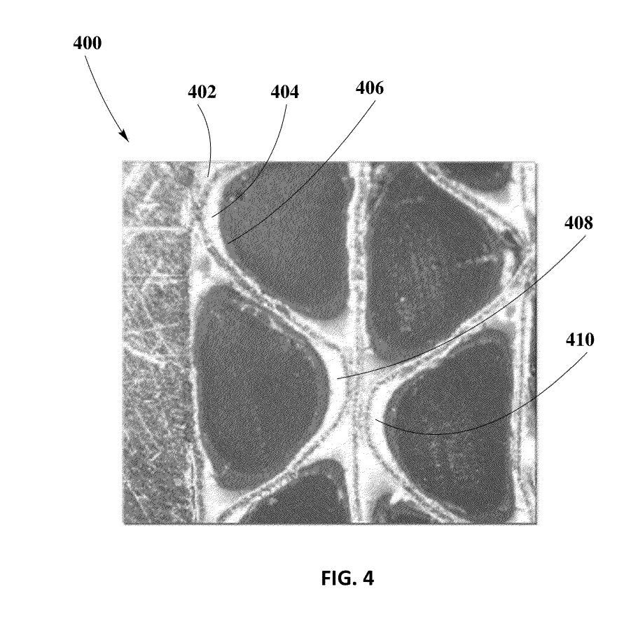

FIG. 4 shows a cross section magnification for visual inspection 400 of catalyst samples of a D40 mm×L60 mm, 300 CPSI metallic substrate, with WC loadings 100 g/L and OC loading of 120 g/L. FIG. 4 depicts a cross section of catalyst sample for verification of coating uniformity 402, WC loading thickness 404, OC loading thickness 406, and coating uniformity 408. Magnification of WC loading thickness 410, and OC loading thickness 406 may assist in the verification of coating uniformity in the samples.

From visual inspection 400 may be seen that for sample with WC loadings of 100 g/L and OC loading 120 g/L there is solid boundary between WC and OC loadings, showing uniform coating at the periphery of bottom section.

Verification of Washcoat Adhesion

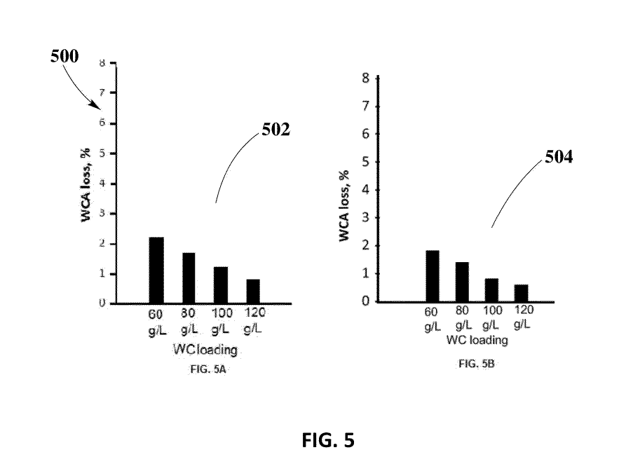

FIG. 5 shows % WCA loss 500 for fresh and aged ZPGM catalyst samples on a D40 mm×L60 mm, 300 CPSI metallic substrate, according to an embodiment.

WCA may be verified for samples prepared according to formulation of catalyst samples in example #1. Verification may be performed using a washcoating adherence test as known in the art. The washcoat adhesion test in present disclosure is performed by quenching the preheated substrate at 550° C. to cold water with angle of 45 degree for 8 seconds followed by re-heating to 150° C. and then blowing cold air at 2,800 L/min. Subsequently, weight loss may be measured to calculate weight loss percentage, which is % WCA loss in present disclosure.

FIG. 5A presents verification of % WCA loss 502 for fresh ZPGM catalyst samples on a D40 mm×L60 mm, 300 CPSI metallic substrate. As may be seen, fresh samples with WC loading of 60 g/L show % WCA loss of about 2.2%; fresh samples with WC loading of 80 g/L show % WCA loss of about 1.7%; fresh samples with WC loading of 100 g/L show % WCA loss of about 1.2%, and fresh samples with WC loading of 120 g/L show % WCA loss of about 0.8%, which is the lowest percentage of WCA loss that result from the analysis of fresh samples with different WC loading according to principles in the present disclosure. As may be seen in % WCA loss 502, increasing the WC loading produces a decrease in WCA loss.

FIG. 5B presents verification of % WCA loss 504 for aged ZPGM catalyst samples on a D40 mm×L60 mm, 300 CPSI metallic substrate. Aging of ZPGM catalyst samples may be performed at 900° C. for 4 hours under dry condition. As may be seen, aged samples with WC loading of 60 g/L show % WCA loss of about 1.8%; fresh samples with WC loading of 80 g/L show % WCA loss of about 1.4%; fresh samples with WC loading of 100 g/L show % WCA loss of about 0.8%, and fresh samples with WC loading of 120 g/L show % WCA loss of about 0.6%, which is the lowest percentage of WCA loss that result from the analysis of aged samples with different WC loading according to principles in the present disclosure. As may be seen in % WCA loss 504, WCA loss decreases after aging the ZPGM samples. The comparison of % WCA loss from FIG. 5A and FIG. 5B shows that WCA may be improved to an optimal level when ZPGM catalyst samples are aged at 900° C. for 4 hours under dry condition. The optimal WCA may be achieved for aged ZPGM catalyst samples with WC loading of 120 g/L.

A thicker layer of WC may be provided by higher WC loadings, which may result in a better adhesion between OC particles and WC particles, because the OC particles may penetrate through WC layer. This can also be seen from the verification of coating uniformity in visual inspection 400, where the magnification of resulting WC loading thickness 404, 410 and OC loading thickness 406 show that the OC layer penetrates inside the WC layer.

The higher penetration or connection between the OC and WC layers, may lead to better WCA. Therefore, as shown in FIG. 5A and FIG. 5B, increasing the WC loading reduces the WCA loss. Additionally, WCA may strongly depend on the substrate cell density and it may be expected that WCA loss may be less for metallic substrates of greater cell density, such as the cell density of 300 CPSI used for the catalyst samples in the present disclosure.

Verification of Catalyst Oxidation Activity

Verification of catalyst oxidation activity of fresh ZPGM catalyst samples in example #1 may be performed under lean exhaust condition using a total flow of 20.1 L/min with toluene as feed hydrocarbon.

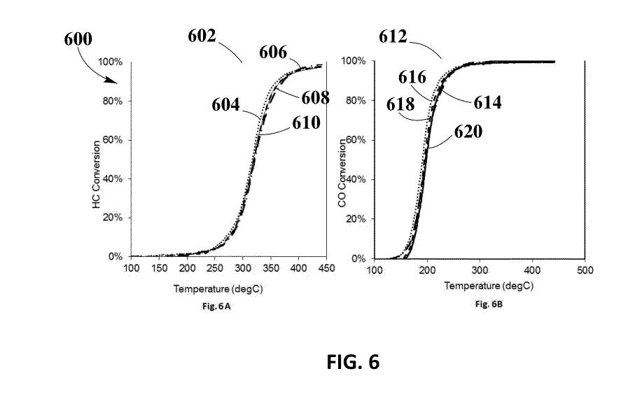

FIG. 6 shows catalyst oxidation activity profile 600 in HC and CO conversion for fresh ZPGM catalyst samples coated on a D40 mm×L60 mm, 300 CPSI metallic substrate, prepared with the formulation described in example #1, according to an embodiment. For all samples OC loading was fixed at 120 g/L.

FIG. 6A shows HC conversion graph 602 for WC loadings in the present disclosure. HC conversion 604 is for WC loading of 60 g/L (dot and dash line); HC conversion 606 is for WC loading of 80 g/L (dot line); HC conversion 608 is for WC loading of 100 g/L (dash line); and HC conversion 610 is for WC loading of 120 g/L (solid line).

FIG. 6B shows CO conversion graph 612 for WC loadings in the present disclosure. CO conversion 614 is for WC loading of 60 g/L (dot and dash line), CO conversion 616 is for WC loading of 80 g/L (dot line). CO conversion 618 is for WC loading of 100 g/L (dash line) and CO conversion 620 is for WC loading of 120 g/L (solid line).

The temperatures for T50 for HC conversion were registered as follows: for WC loading of 60 g/L 322° C., for WC loading of 80 g/L 318° C., for WC loading of 100 g/L 319° C., and for WC loading of 120 g/L 321° C. Monitoring of the catalyst activity of samples in HC and CO conversion indicates that no difference in performance may be observed for fresh ZPGM catalyst samples prepared with different WC loadings, as described in example #1.

As can be seen from the verification of washcoat loading and reproducibility of ZPGM catalyst samples in the present disclosure, as well as their behavior under back pressure, achieved coating uniformity, optimal reduction of WCA loss, and improved catalyst activity, in the process of optimization of ZPGM catalysts may be demonstrated that variation of WC thickness within range of about 60 g/L to about 120 g/L results in higher BP for loading of 120 g/L and higher WCA for loading of 60 g/L and 80 g/L. Since loading of 100 g/L shows very good coating uniformity and activity, and also very low WCA loss and BP for D40 mm×L60 mm, 300 CPSI metallic substrate, selecting a WC loading of 100 g/L may help manufacturing of ZPGM catalyst on different size of metallic substrate rather than D40 mm×L60 mm, 300 CPSI to be within desired range of WCA loss, coating uniformity, back pressure and activity for fresh and aged samples.

1. A method for improving performance of catalytic systems, comprising:
providing at least one substrate;
depositing a washcoat suitable for deposition on the substrate, the washcoat comprising at least one oxide solid further comprising at least one carrier metal oxide and at least one first ZPGM catalyst;
depositing an overcoat suitable for deposition on the substrate, the overcoat comprising at least one second ZPGM catalyst;
wherein the washcoat is deposited at about 60 g/L to about 120 g/L;
wherein the overcoat is deposited at about 120 g/L; and
wherein the substrate exhibits a back pressure of about 0.400 kPa to about 0.750 kPa when receiving an air flow of about 1.0 m³/min.

2. The method according to claim 1, wherein the washcoat is heated for about 2 to about 6 hours.

3. The method according to claim 1, wherein the washcoat is heated for about 4 hours.

4. The method according to claim 1, wherein the washcoat is heated to about 900° C.

5. The method according to claim 1, wherein the substrate about 100 cells per square inch.

6. The method according to claim 1, wherein the substrate comprises metal.

7. The method according to claim 1, wherein the at least one carrier material oxide comprises one selected from the group consisting of aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof.

8. The method according to claim 1, wherein the at least one second ZPGM catalyst comprises at least one transition metal and at least one rare earth metal.

9. The method according to claim 1, wherein the at least one transition metal is selected from the group consisting of chromium, manganese, iron, cobalt, nickel, niobium, molybdenum, tungsten, copper, and mixtures thereof.

10. The method according to claim 1, wherein the at least one rare earth metal is cerium.

11. The method according to claim 1, wherein the overcoat further comprises at least one carrier material oxide.

12. The method according to claim 11, wherein the at least one carrier material oxide is selected from the group consisting of aluminum oxide, doped aluminum oxide, spinel, delafossite, lyonsite, garnet, perovksite, pyroclore, doped ceria, fluorite, zirconium oxide, doped zirconia, titanium oxide, tin oxide, silicon dioxide, zeolite, and mixtures thereof.

13. The method according to claim 1, wherein the depositing of the washcoat comprises the use of an aqueous slurry.

14. The method according to claim 1, wherein the washcoat is deposited at about 100 g/L.

15. The method according to claim 1, wherein an increase in washcoat loading decreases washcoat adhesion loss.

16. The method a claim 1, wherein the substrate has dimensions of about 40 mm by about 60 mm.

17. The method according to claim 1, wherein the substrate about 300 cells per square inch.

18. The method according to claim 1, wherein the washcoat further comprises at least one oxygen storage material.

19. The method according to claim 18, wherein the at least one oxygen storage material is selected from the group consisting of cerium, zirconium, lanthanum, yttrium, lanthanides, actinides, and mixtures thereof.

20. The method according to claim 8, wherein the ratio of the at least one oxygen storage material to the at least one carrier metal oxide is 2:3.

21. The method according to claim 1, wherein the loss of deposited washcoat is less than about 5%.

22. The method according to claim 1, wherein the loss of deposited washcoat is less than about 2%.

23. The method according to claim 1, wherein the loss of deposited washcoat is less than about 1%.
